(19) United States
(12) Patent Application Publication
(10) Pub. No.: US 2006/0213875 A1
(43) Pub. Date: Sep. 28, 2006

(54) Flame photometric detector of gas chromatograph

(75) Inventor: Shigeaki Shibamoto, Kyoto-shi (JP)

Correspondence Address: KANESAKA BERNER AND PARTNERS LLP, SUITE 300, 1700 DIAGONAL RD, ALEXANDRIA, VA, 22314-2848, US

(73) Assignee: SHIMADZU CORPORATION, Kyoto-shi (JP)

(21) Appl. No.: 11/088,929

(22) Filed: Mar. 25, 2005

(51) Int. Cl. B23K 9/00; B23K 9/02

(52) U.S. Cl. 219/121.5

(57) ABSTRACT

A flame photometric detector of a gas-chromatograph is arranged such that a mixed gas of a column outflow gas and a fuel gas is ejected from a tip of a nozzle, and the mixed gas and supporting gas are mixed and burn inside a combustion chamber. Light with a particular wavelength is generated from a flame and detected. The flame photometric detector for the gas-chromatograph includes a cylindrical member disposed inside a fuel gas passage of the nozzle. It is possible to change an inner diameter or a height a tip of a nozzle by changing the cylindrical member.

### BACKGROUND OF THE INVENTION AND RELATED ART STATEMENT

The present invention relates to a flame photometric detector to be used as a detector of a gas-chromatograph.

A flame photometric detector (FPD) is a detector used for a gas-chromatograph, and has high sensitivity relative to a compound of sulfur or phosphorus. FIG. 1 shows a cross sectional view of a structure of a conventional FPD (refer to Patent Document 1). In FIG. 1, reference numerals 1 to 3 represent gas-chromatograph channels connected to the FPD. More specifically, carrier gas adjusted at a constant pressure or constant flow rate is introduced from a carrier gas introductory part, and flows into the detector (FPD cell 4) through a sample inlet 2 and a column 3. A sample from the sample inlet 2 is separated into each constituent while passing through the column 3 with the carrier gas. Hereinafter, the carrier gas flowing out of the tip of the column and constituent gas of a separated sample constituent are referred to as column outflow gas.

Hydrogen as fuel gas and air as supporting gas are introduced into the FPD cell 4 through conduits 51 and 61, respectively. The introduced fuel gas flows upwardly through a fuel gas passage 5 along a central axis of the cylindrical FPD cell. An upper end of the fuel gas passage 5 forms a nozzle 7 opening toward a fuel chamber 42. A tip of the column is inserted into the fuel gas passage 5 from a lower side of the FPD cell 4, and fixed by a nut 31 and a ferrule 32. The supporting gas passes through a supporting gas passage 62 surrounding the fuel gas passage 5, and is ejected from a supporting gas outlet 6 disposed around the nozzle. The supporting gas outlet 6 is formed of a number of eyeholes opening near the nozzle toward the fuel chamber 42. Alternatively, the supporting gas outlet 6 can be constituted as a gap above a slit surrounding the nozzle. Hydrogen and air are used as the fuel gas and the supporting gas, and different types of gases other than the gases previously mentioned can be used.

The fuel chamber 42 is a space above the nozzle 7 covered with a cell external cylinder 41. The fuel gas reacts with oxygen in the supporting gas, and burns to form a flame 8. Exhaust gas after burning is discharged out of a vent 43 at an upper part of the cell external cylinder.

The column outflow gas is mixed with the fuel gas inside the fuel gas passage 5, and is blown into the flame 8 from the nozzle 7. When the sample contains a constituent including sulfur and phosphorus, light with a particular wavelength is generated in the flame 8. An intensity of light is measured by a photometry 10 provided at a side of the flame 8. More specifically, light emanated from the flame 8 transmits through a quartz window 13, and enters the photometry 10. Then, light emanated from the flame 8 passes through an interference filter 11, so that light with a particular wavelength passes through as a measuring object. Light emanated from the flame 8 is changed into an electronic signal at a photo multiplier 12, and emitted to an outside measuring circuit (not shown).

Patent Document 1: Japanese Patent Publication (Kokai) No. 2002-22661

In the gas-chromatograph analysis, a single device is used for the analysis under various different conditions such as an inner diameter of an analysis column, a flow rate of carrier gas, and an analytical condition. When the analytical condition, especially the type of column, is changed, it is necessary to change the nozzle of the flame photometric detector suitable for the analytical condition. For example, when a capillary column is used, a flow rate of the carrier gas is different from that of a packed column. When a nozzle does not have an optimal inner diameter suitable for a flow rate of the gas, a flame does not burn well, thereby losing flame.

Further, depending on the condition, a distance between the tip of the nozzle and a luminescence point of a sample may be different. That is, when gas is introduced into a flame at a large line speed, the distance between the tip of the nozzle and a luminescence point of a sample becomes large. When a sample takes time to reach a luminescence point, the distance to the luminescence point of the sample also becomes large. Accordingly, depending on the analytical condition, the luminescence point may be changed, and it is necessary to change a height of the tip of the nozzle, so that the photo multiplier can detect efficiently.

In the conventional detector, it is possible to change the column from inside a column oven. However, it is necessary to adjust the nozzle from a side of the detector, i.e., outside the column oven. Accordingly, it is necessary to perform a complicated operation such as removing a lid of the detector.

In view of the above-mentioned problems, an object of the present invention is to provide an FPD detector of a gas-chromatograph in which it is possible to change an inner diameter or a position of a nozzle suitable for an analytical condition without replacing the nozzle. It is possible to perform the operation from a side of a column oven without removing a lid of the detector. Accordingly, it is possible to adjust the nozzle as well as change a column.

Further objects and advantages of the invention will be apparent from the following description of the invention.

### SUMMARY OF INVENTION

In order to achieve the objects mentioned above, according to the present invention, a flame photometric detector of a gas-chromatograph is arranged such that a mixed gas of a column outflow gas and a fuel gas is ejected from a tip of a nozzle, and the mixed gas and supporting gas are mixed and burn inside a combustion chamber. Light with a particular wavelength is generated from a flame and detected. The flame photometric detector for the gas-chromatograph includes a cylindrical member disposed inside a fuel gas passage. It is possible to change an inner diameter or a height a tip of a nozzle through changing the cylindrical member.

Depending on an analytical condition, a luminescence point of a sample may be changed. Accordingly, even when luminescence has a same intensity, a photo multiplier may measure light with a different intensity. A factor changing the luminescence point includes a flow rate of carrier gas, an analysis subject, and the like, in addition to an inner diameter of an analysis column. When the analytical condition is changed, there is a case that it is desirable to change an inner diameter or a height of a nozzle to improve analysis sensitivity.

In the present invention, it is possible to replace the cylindrical member with another cylindrical member with a different inner diameter or a different length, thereby changing the inner diameter of the nozzle or the height of the tip of the nozzle. Accordingly, it is possible to obtain a luminescence point of the sample at an optimal height. As a result, it is possible to obtain a stable flame, and the photo multiplier receives light with a high intensity, thereby improving sensitivity of the flame photometric detector. Further, it is possible to change the cylindrical member from a side of a column oven at the same time when a column is changed, thereby making the operation efficient.

### BRIEF DESCRIPTION OF THE DRAWINGS

FIG. 1 is a view showing a structure of a conventional FPD;

FIG. 2(a) is a view showing a nozzle portion of an FPD according to an embodiment of the present invention, and FIG. 2(b) is a view showing a nozzle portion of the conventional FPD;

FIG. 3 is a view showing a cylindrical member according to the embodiment of the present invention;

FIG. 4 is a view showing a structure of a conventional FPD; and

FIGS. 5(a) to 5(c) are views showing cases, wherein the present invention is applied to the FPD shown in FIG. 4.

### DETAILED DESCRIPTION OF PREFERRED EMBODIMENTS

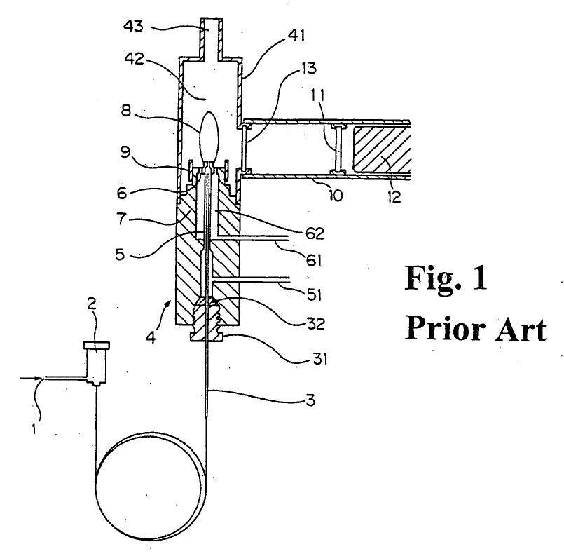

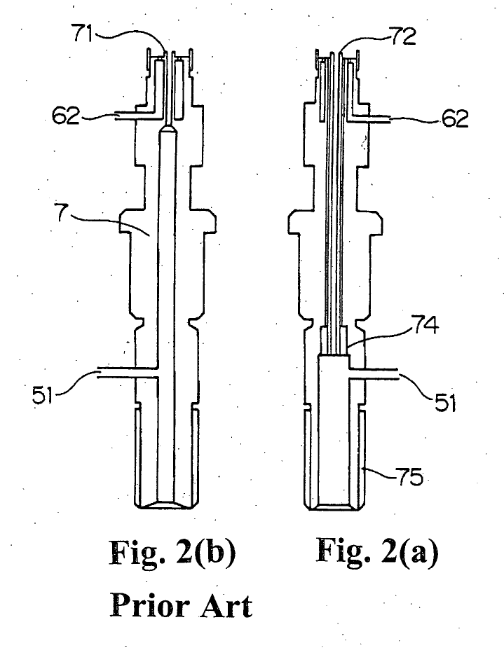

Hereunder, embodiments of the present invention will be explained with reference to the accompanying drawings. FIG. 2(a) shows an FPD nozzle according to an embodiment of the present invention. FIG. 2(b) shows a conventional FPD nozzle. FIGS. 2(a) and 2(b) show only the nozzles inside FPD detectors, and a part not shown in the drawing is the same as that in FIG. 1.

According to the embodiment of the present invention, the nozzle has a tip different from that of the conventional nozzle. A tip 71 of the conventional nozzle is formed of a single part, and has a constant height. In the embodiment, a cylindrical member 72 is provided inside the nozzle as a separate part, and a tip of the cylindrical member 72 protrudes from the tip of the nozzle.

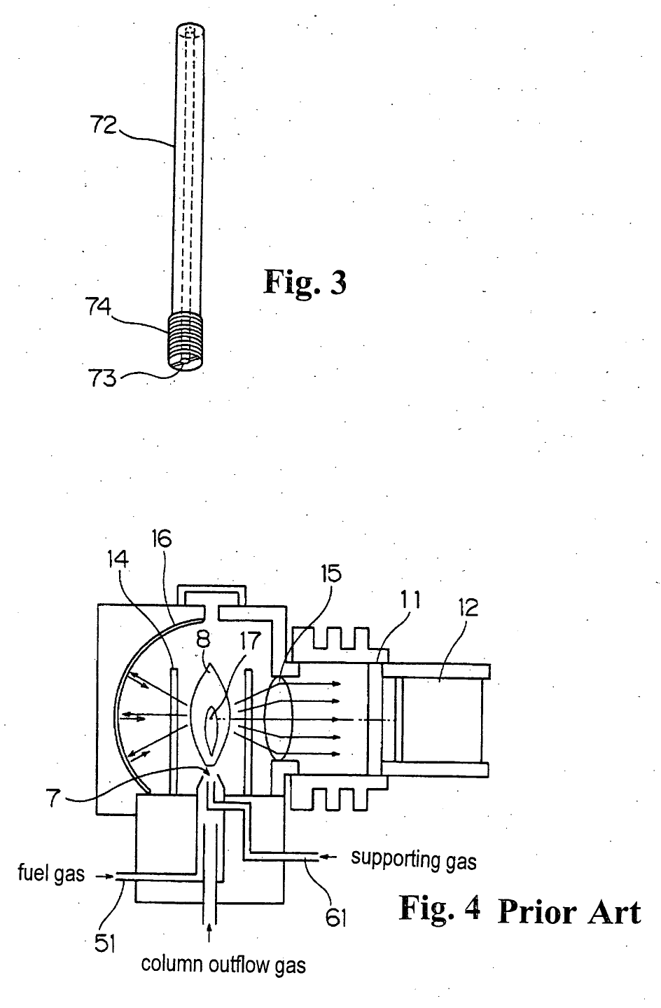

FIG. 3 is a view showing the cylindrical member 72 according to the embodiment of the present invention. As shown in FIG. 3, the cylindrical member 72 is provided with a screw portion or thread 74 and a groove 73 at a lower portion thereof. The cylindrical member 72 is preferably formed of a material such as quartz to which a sample component does not easily adhere. A screw portion is also formed inside the nozzle, so that the screw portion 74 of the cylindrical-member 72 can be screwed into the screw portion.

The groove 73 is provided for screwing a screw with a screwdriver. After the cylindrical member 72 is inserted into the nozzle from a side of a column oven, the screwdriver is inserted into the groove 73 to fix the screw portion 74. Depending on an extent that the screw portion 74 is screwed in, the cylindrical member 72 can move in a direction that gas is ejected, thereby adjusting a height of the tip. An end of the column is inserted just under the screw portion 74, or inside the cylindrical member 72. Column outflow gas from the column passes through the cylindrical member 72, and is guided to a combustion chamber, so that a sample component in a flame emits light. It is possible to change the height of the tip of the cylindrical member screwed into the nozzle, thereby changing a luminescence point of the sample component in the column outflow gas.

When the analysis is performed under a different condition, the column outflow gas may be ejected at a different line speed, thereby changing the luminescence point of the sample component. Accordingly, when a packed column is used, the screwed may be screwed into a deepest point to raise the cylindrical member, thereby raising the luminescence point of the sample component in the column outflow gas. When a capillary column is used, the screwed may be screwed less to lower the cylindrical member, thereby lowering the luminescence point.

As described above, depending on an extent that the screw portion is screwed in, it is possible to properly adjust the luminescence point of the sample component in the column outflow gas. The adjustment method is not limited to the screw structure, and a fitted in structure or a sliding structure may be applicable. The adjustment method may be automated. Alternatively, the cylindrical member may be detachable, and several cylindrical members with different lengths are provided to be exchangeable. When several cylindrical members have different inner diameters, it is possible to change the inner diameter as well as the height. Further, it is possible to adjust the cylindrical member from the side of the column oven, thereby making the operation simple.

The flame photometric detector of a gas-chromatograph may have a structure shown in FIG. 4. In this case, the present invention is more effective. The flame photometric detector of a gas-chromatograph shown in FIG. 4 is disclosed in Japanese Patent Publication (Kokai) No. 11-237340. The flame photometric detector includes a convex lens 15 disposed between the flame 8 and the photo multiplier 12 for collimating scattered light from a sample component in the flame and for irradiating incident light on an incident surface of the photo multiplier. A concave mirror 16 is arranged at a side opposite to the photo multiplier with the flame in between. The convex lens 15 converts light reflected from the concave mirror 16 to vertical light to be detected at the photo multiplier.

With the FPD detector having the structure described above, a majority part of light emitted from the flame reaches the photo multiplier. The convex lens 15 and the concave mirror 16 are arranged to focus at a specific focal point 17, and it is desirable that light with a largest intensity is emitted from the specific focal point 17. In the conventional detector, the tip of the nozzle is located at a constant height. Accordingly, when the analytical condition is changed, the luminescence point of the sample component may be shifted from the specific focal point, thereby reducing light reaching the photo multiplier.

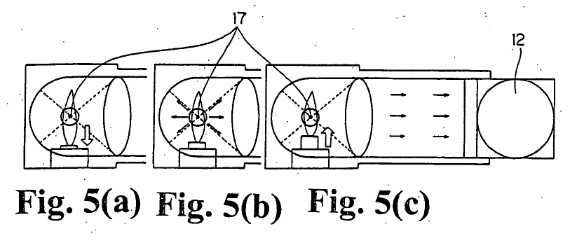

In the invention, as shown in FIGS. 5(a) to 5(c), it is possible to change a position of the nozzle to change a distance between the tip of the nozzle and the luminescence point of the sample component, thereby moving the luminescence point closer to the specific focal point 17. FIG. 5(a) shows a case that the cylindrical member is lowered when a line speed is high, and FIG. 5(c) shows a case that the cylindrical member is raised when a line speed is low. According to the present invention, depending on the analytical condition, it is possible to adjust the position of the cylindrical member so that the luminescence point of the sample component moves closer to the specific focal point. Accordingly, it is possible to increase an amount of light reaching the photo multiplier, thereby improving analytical sensitivity.

The disclosure of Japanese Patent Application No. 2004-006072, filed on Jan. 13, 2004, is incorporated in the application.

While the invention has been explained with reference to the specific embodiments of the invention, the explanation is illustrative and the invention is limited only by the appended claims.

What is claimed is:

1. A flame photometric detector of a gas-chromatograph, comprising:
a nozzle having a tip for ejecting column outflow gas and a gas passage therein, and
a cylindrical member removably attached inside the gas passage from a side opposite to the tip.

2. A flame photometric detector according to claim 1, wherein said nozzle further includes a fuel gas passage so that a mixture of the column outflow gas and fuel gas passes through the cylindrical member.

3. A flame photometric detector according to claim 1, wherein said nozzle has a female screw portion formed in an inner surface of the gas passage, and said cylindrical member has a male screw portion formed on an outer surface thereof so that the cylindrical member can be screwed in the nozzle.

4. A flame photometric detector according to claim 3, wherein said cylindrical member further includes a screw groove at the side opposite to the tip to adjust a height with respect to the nozzle.

5. A flame photometric detector according to claim 4, wherein said nozzle further includes a supporting gas passage for providing a supporting gas around the tip, and a thread for attaching a column at the side opposite to the tip.
